(19) United States
(12) Patent Application Publication
(10) Pub. No.: US 2007/0118751 A1
(43) Pub. Date: May 24, 2007

(54) METHOD OF DIGITALLY SIGNING A CONTRACT

(75) Inventors: Timothy Parlett, London (GB); Simon Joshua Deane-Johns, London (GB)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: ZOPA LIMITED, London (GB)

(21) Appl. No.: 11/561,105

(22) Filed: Nov. 17, 2006

Related U.S. Application Data
(60) Provisional application No. 60/737,960, filed on Nov. 18, 2005.

(51) Int. Cl. H04L 9/00

(52) U.S. Cl. 713/176

(57) ABSTRACT

A device and method for digitally signing contracts. A first contract is signed in response to an action by a signor. A second contract is also signed in response to an action by the signor. The action that signs the second contract is an extension of the same action that is used to sign the first contract. By this method a plurality of contracts may be signed with a single extended action, in contrast to existing methods where a plurality of contracts are signed by repeated, discrete actions. A signor may be presented with a summarised, partial or full version of a contract before and after the contract is signed. Multiple contracts may be presented in list form and each contract on the list may be represented as a single line of text, or a few lines of text.

### CLAIM OF PRIORITY

This application claims the benefit of provisional application Ser. No. 60/737,960, filed Nov. 18, 2005.

### BACKGROUND TO THE INVENTION

This invention relates to a method of digitally signing a contract in a list of contracts.

Contracts and other legal agreements are an inescapable part of modern life. Every day the average person will enter into a large number of contracts, mostly by informal or implied acceptance of terms and conditions. Important written contracts, however, require formal signatures from the parties to become legally binding.

Revolutions in computing, and in particular the internet, have changed the way in which contracts may be signed. Electronic (or digital) signatures have become common place and, since the Electronic Signatures in Global and International Commerce Act (2000) in the United States, are now as legally valid as ink signatures.

Recent developments in online borrowing have provided systems that match borrowers to appropriate lenders. In particular, one system described in co-pending U.S. patent application Ser. No. 11/191,775, the subject matter of which is incorporated herein by reference, provides that borrowed funds are provided by a plurality of independent lenders. In such a system there exists a contract between the borrower and each lender that provides funds. It is possible that a large number of contracts could thus exist and the borrower must actively sign each contract. Therefore it is a considerably burdensome task for the borrower to sign and consider all of the elements of each contract in turn.

It is an intention of the current invention to provide a method that enables a party to rapidly sign a contract among a plurality of contracts in a list.

### SUMMARY OF THE INVENTION

According to the present invention there is provided a method of digitally signing a plurality of contracts, comprising the steps of: signing a first contract in response to an action by a signor; and signing a second contract in response to an action by the signor, wherein the action that signs the second contract is an extension of the same action that is used to sign the first contract.

By this method a plurality of contracts may be signed with a single extended action, in contrast to existing methods where a plurality of contracts are signed by repeated, discrete actions. This means that long lists of contracts may be signed with significant ease and speed. Preferably the action that signs the second contract is a continuous extension of the action that signs the first contract.

It may be desirable for a signor to be able to see at least a summarised version of a contract before the contract is signed. Indeed such a step may be a requirement if a signed contract is to be found legally valid. Therefore, the method may further comprise the step of displaying an identification of a contract before it is signed.

The displayed identification of a contract may comprise information about the contract, for example a list of the parties with whom the contracts are to be entered into. Alternatively or additionally, for borrowing contracts the displayed identification may comprise a list of offered funds from each lender. Thus, each contract in the list may be represented as a single line of text, or a few lines of text. This is particularly advantageous in creating a compact list rather than a list comprising the full text of each of the contracts.

Despite the advantages of providing a compact list, it may be desirable to allow a party to be able to examine the full text of a contract, in order to be certain about the ramifications of their signature. Therefore there may be provided means for selecting the displayed identification of a contract and causing the display of further details of that contract, or full details of that contract as appropriate.

It may also be desirable to allow a signor to sign a contract individually. Whereas it is preferable that a user should be able to sign a large number of contracts with ease and speed, it may also be provided that a user can accept contracts individually in a conventional manner, such as checking an “I accept” box.

The method may further comprise the step of displaying an identification of a contract after it has been signed, together with an indication that the contract has been signed. It may be advantageous for a signor to be able to see a summarised version of a contract after it has been signed. This may provide confirmation to the signor that the contract has been successfully signed. A convenient indication that the contract has been signed may be a checked box.

Preferably the method further comprises the step of displaying at least a portion of the list of contracts. A number of contracts, or summaries thereof, may be displayed in a window. As contracts in the list are signed, the details of the contracts displayed in the window may change accordingly. It may be preferable to display a mixture of signed and unsigned contracts in the window whilst the signing process takes place. Before any contracts have been signed, all of the contracts in the window may be unsigned, and after all of the contracts have been signed, all of the contracts in the window may be signed.

The action that signs the first contract may be the selection of a signing tool. Most preferably the method is carried out on a computer so that the contracts may be digitally signed. In a computing environment, there are many objects that are capable of being selected as the signing tool. For example, the signing tool may be a specific key on the keyboard, or a button provided on a mouse; further the signing tool may be an icon that is selectable with a graphical pointer or a touch-sensitive screen. Preferably the signing tool is a displayed icon, and the displayed icon is arranged to be selected by a pointer.

Instructions may be displayed for the signor and further the instructions may be updated according to the status of the plurality of contracts. In this way the system may be easy to operate for a signor. Preferably the signing instructions are arranged to be displayed adjacent to the signing tool.

The signing tool may be arranged to become inactive after all of the contracts in the plurality of contracts are signed. Thus, it may be clear to the signor that there are no contracts that remain unsigned; this may act as a suitable indication for the signor to proceed to the next step.

The extension of the selection of the signing tool may be the continued selection of the signing tool.

The method may further comprise the step of displaying an indication of a current contract in the list. By indicating a current contract, an action may be provided for signing contracts. Specifically, the action that signs the first contract may be the movement of the displayed indication from one contract to another contract in the list.

The current contract may be indicated in many different ways, and several examples are provided here.

In a first example, the current contract may be highlighted in the list. According to this first example the action of moving the highlighted indication from one contract to another may cause a contract to be signed. It may be appropriate if the signed contract is the contract that the highlighted indication has moved from, or alternatively the contract that the highlighted indication has moved to.

In a second example, the current contract may have a predetermined location in a displayed portion of the list. Again by way of example, the current contract may be the first contract, the second contract, or the first unsigned contract in the list. In the embodiment where there is a window defining the displayed portion of the list, the indication of a current contract may change when a new portion of the list is displayed in the window. This movement in the indication of the current contract may cause a contract to be signed; it may be that the contract to be signed is the new current contract, or equally it may be the old current contract.

As a third example, the current contract may be indicated by its adjacency to the tab of a scroll bar. In this way, the indication of a current contract may be moved when the tab of a scroll bar moves with respect to the contracts in the list. This feature may enable fast and easy offering or acceptance of a contract within a recognisable computer display platform. In addition, the tab of a scroll bar often offers the quickest way to scroll to the bottom of a list in an internet browser. Therefore this feature may offer a fast method of signing an entire list of contracts. Furthermore while the tab of a scroll bar may be used for indicating a current contract, other means may be used for simply scrolling through and examining the list without signing any contracts.

The extension of the movement of the displayed indication from one contract to another contract in the list may be the continuous movement of the displayed indication to yet another contract in the list.

The rate at which contracts are signed may be increased during the continued selection of the signing tool. In this way, the rate at which contracts are signed may increase and a long list of contracts may be quickly signed. At the same time, a user may change their mind without having signed a large number of contracts.

The method may further comprise the step of recording the time of signing of a contract. The recording of the time of signature associated with a contract creates certainty for all parties as to the time at which the contract becomes enforceable. The digital signature and the time of signing may be displayed. By displaying the signature along with the time of signing, parties to the contract may obtain further certainty as to the contract's legal status.

A copy of a signed contract may be saved electronically. Once saved, the signed contract may be accessible by parties in electronic form either for downloading or for future reference.

The contract arranged in the list of contracts may be a borrowing or lending contract in a system of matching lenders of money with borrowers of money, wherein a borrower of money receives funds from a plurality of lenders. In such a system the borrower of money is obliged to enter into a contract with each lender. This is an exemplary example of where a fast and convenient method of accepting or offering a plurality of contracts is desirable.

The method may further comprise the step of examining a contract in the list of contracts for a digital signature, and indicating if all the contracts have been signed. This feature may be used to inform a party to the contract whether there remain contracts in the list of contracts that have not yet been signed. In the situation where a borrower of money receives funds from a plurality of lenders, it may be that contracts within the list of contracts are inter-dependent insomuch as they form part of a larger agreement. Therefore it may be particularly important in certain embodiments to ensure that partial signing of a list of contracts does not occur.

The signature in a contract may be undone after a predetermined time period has elapsed from the signing of the contract. Preferably the method does not include the undoing step if all of the contracts have been signed and if a user has indicated that they wish to proceed with the list of signed contracts.

According to another aspect of the present invention there is provided a method of digitally signing a contract comprising the steps of: displaying at least part of a list of contracts; displaying an indication of a current contract in the list; moving the displayed indication of a current contract from one contract to another contract in the list in response to a user input; and digitally signing a contract in response to the indication of a current contract moving from one contract to another contract in the list.

The indication of a current contract may be rapidly moved from one contract to another and indeed rapidly moved from contract to contract down a long list. By this method the present invention may provide the advantage that a party may sign a plurality of contracts with significant ease and speed; this is of particular relevance where a large number of contracts need to be signed. In addition, since the indication of a current contract is moved in response to a user input, the signing of a contract remains in direct control of the user. Therefore the present method is able to increase the ease and speed of signing a large number of contracts while remaining legally valid in contract law. A current contract may be indicated by adjacency to the tab of a scroll bar.

According to yet another aspect of the present invention there is provided an apparatus for digitally signing a contract comprising: a display unit which displays at least part of a list of contracts; an indicator for indicating a current contract in the list; a controller for a user that can be used to move the indicator from one contract to another contract in the list; and a digital signing unit which digitally signs a contract in response to the indication of a current contract moving from one contract to another contract in the list.

According to yet another aspect of the present invention there is provided a method of digitally signing a contract comprising the steps of: displaying at least part of a list of contracts; displaying a scroll bar with a scroll tab next to the list of contracts; moving the scroll tab past a contract in response to a user input; and digitally signing a contract in response to the scroll tab moving past a contract in the list of contracts.

According to yet another aspect of the present invention there is provided a computer readable storage medium having stored thereon a computer program, the computer program comprising: a program module which displays at least part of a list of contracts; a program module which displays an indication of a current contract in the list; a program module which moves the displayed indication of a current contract from one contract to another contract in the list in response to a user input; and a program module which digitally signs a contract in response to the indication of a current contract moving from one contract to another contract in the list.

According to yet another aspect of the present invention there is provided an apparatus for digitally signing a plurality of contracts comprising: a digital signing unit; and a controller for a user which enables the user to perform an action, wherein the digital signing unit digitally signs a first contract in response to an action by the user, and digitally signs a second contract in response to an action by the user, wherein the action that signs the second contract is an extension of the same action that is used to sign the first contract.

According to yet another aspect of the present invention there is provided a computer readable storage medium having stored thereon a computer program, the computer program comprising: a program module which responds to an action of a user and an extension of the same action by the user; a program module which digitally signs a first contract in response to the action of the user; and a program module which digitally signs a second contract in response to the extension of the action of the user.

### BRIEF DESCRIPTION OF THE DRAWINGS

Preferred features of the present invention will now be described, purely by way of example, with reference to the accompanying drawings, in which:

FIG. 1 shows a list of contracts including an embodiment of the present invention;

FIG. 2 shows an example of a contract for a borrower in a lending and borrowing system;

FIG. 3 shows an apparatus in which the present invention is embodied;

FIG. 4 shows a portion of a list of contracts including an embodiment of the present invention;

FIGS. 5A-5C show a signing button, usable in an embodiment of the present invention, at various stages during the signing of a plurality of contracts; and

FIG. 6 shows another apparatus in which the present invention is embodied.

### DETAILED DESCRIPTION OF EMBODIMENTS OF THE INVENTION

In the system described in co-pending U.S. patent application 11/191775, a borrower in an online system is provided with funds by a plurality of independent lenders. A borrower makes an application for a loan and the system identifies funds from a plurality of lenders that may be used to supply the loan. On the basis of the terms specified by individual lenders, a rate of interest is determined and this is proposed to the borrower, along with the associated monthly repayments, as a quotation.

Upon receipt of a quotation for a loan, a borrower reviews the offer and decides whether to accept or decline, based on all of the relevant factors. Should the borrower wish to accept, and proceed with the loan, they must make:

a global agreement to the principle of the loan with all of the lenders and the system administrator

an individual agreement with each of the lenders that are supplying the funds

These agreements are contracts and in the present embodiment the agreement takes place online. To agree to an electronic contract, it is possible to make an electronic or digital signature. These signatures are common place and are considered as legally valid as ink signatures, in the United States.

A single global agreement may be considered by a borrower and easily accepted by conventional electronic means, such as checking an “I accept” box.

The problem arises in the current system where multiple indications of acceptance are required. The funds comprising a borrower's requested loan may be supplied by a large number of individual lenders, and a contract must be established with each of the lenders. It is undesirably burdensome for the borrower to consider each contract in turn and check “I accept” boxes since the lenders may number over 50, 100, or perhaps over 1000 in some configurations of the lending system. Equally it is not possible for the borrower to simply “accept all” of the contracts by checking a single box; according to contract law each of these agreements must be individually signed by the borrower.

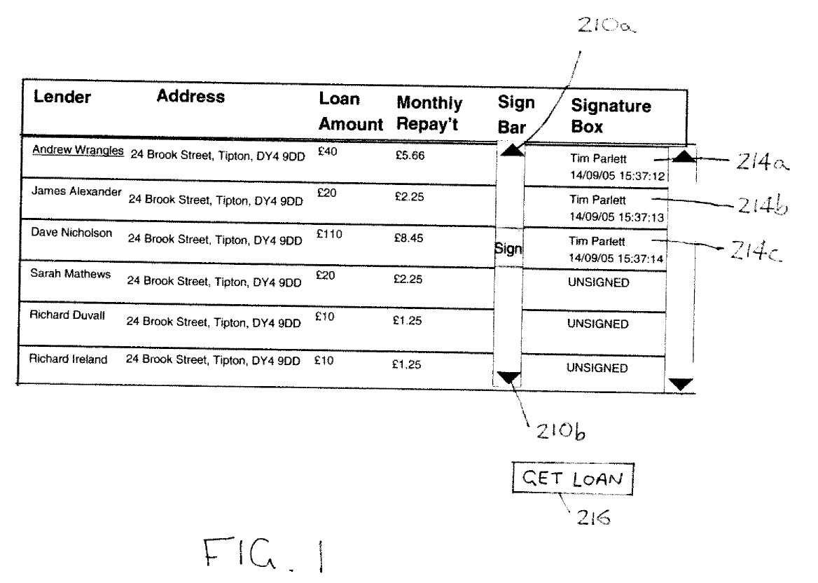

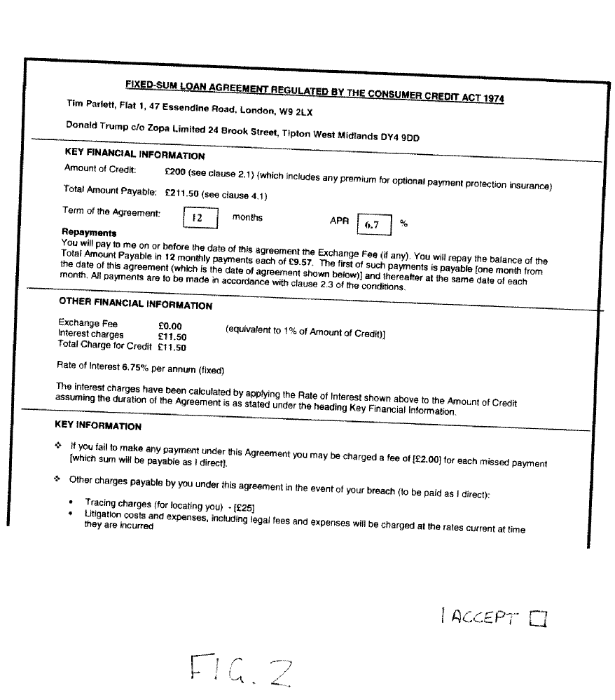

FIG. 1 shows a list of contracts, displayed in a window of an internet browser for example, that a borrower must sign in order to accept the loan quotation. The borrower can see summarised details of the contracts including: the name and address of each lender, the amount offered by the lender to the borrower, and the monthly repayment due in respect of the loan. In the current embodiment the address of the lender is given as the address of the system administrator; this provides a degree of confidentiality for the lender. By clicking on any individual lender the borrower may examine the contract in respect of each one, an example of which is shown in FIG. 2.

With reference to FIG. 2 it may be seen that the only details that will vary in contracts of this type are the name of the lender and the amount offered by the lender (and the related monthly repayments); thus each contract is very similar in nature. When displayed a contract may be individually accepted as may be seen in FIG. 2, however it would take undesirably long for a borrower to examine each contract in the list and accept the terms of it in this manner. Additionally a contract may be individually signed in the list by conventional means such as checking an “I accept” box, for example.

Typically internet browsers have windows that may be scrolled through by means of:

“up” and “down” arrows of a scroll bar (210a, 210b in FIG. 1)

the roller wheel of a mouse

keyboard arrow keys or Page Up/Page Down keys

the tab of a scroll bar

In a first exemplary embodiment of the present invention, the contracts that constitute the loan quotation are displayed on a list in a window of an internet browser. A borrower may scroll through the list of contracts by means of (i), (ii) or (iii). Each of the contracts in the list may be examined, by clicking on the contract in the display window, and accepted individually. Alternatively each contract may be accepted by scrolling past the contract in the list by use of the tab 212 of the scroll bar. As the tab 212 of the scroll bar passes a contract on the screen the contract is digitally signed by the borrower, examples of this may be seen in FIG. 1 (214a-214c). Should the borrower drag the scroll bar from the top of the list of contracts to the bottom, they would rapidly pass by and accept all of the contracts in the loan quotation offer. Using the tab of the scroll bar for this means is advantageous since this is generally the quickest method of scrolling to the bottom of a list in an internet browser.

When a contract is digitally signed, a time stamp derived from a clock on the system server is stored along with the digital signature. In this exemplary embodiment of the invention this time stamp is displayed on the screen so that the borrower may have certainty in the event and time of signing.

Once the borrower is satisfied that they have signed all of the contracts they may click on the “Get Loan” button 216 as seen in FIG. 1. By clicking the “Get Loan” button 216 the borrower gives a final confirmation that they wish to be legally bound by the signed contracts. Selection of this button activates a checking procedure (not shown). The checking procedure examines each of the contracts within the loan quotation to check whether they have been signed by the borrower. If any of the contracts remain unsigned the checking procedure will output an error message and the borrower will be required to sign the outstanding contracts, either by signing them individually or by using the tab of the scroll bar, in order to proceed. In another embodiment, incomplete signing is prevented by only making the “Get Loan” button 216 visible once all of the contracts have been signed.

Once a contract has been signed a copy of it is saved electronically and stored centrally by the system administrator. In addition a separate copy of the contract may saved, for example, as a pdf file. This separate copy may be available to be downloaded by either party, or by the system administrator.

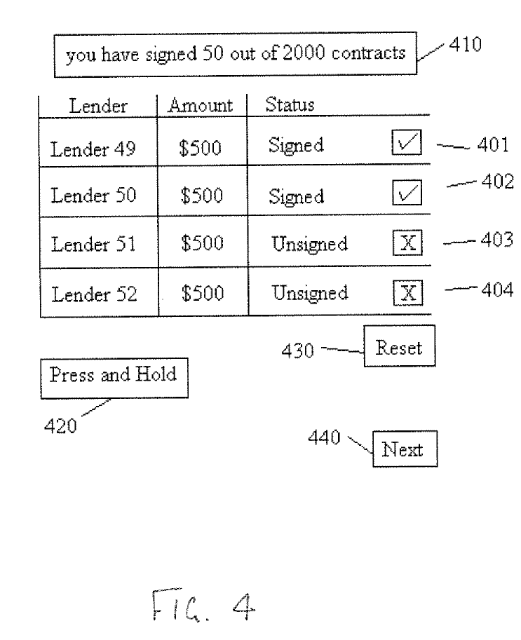

FIG. 4 shows a portion of a list of contracts, displayed in a window of an internet browser. Four contracts 401, 402, 403, 404 out of two thousand are displayed in the window. An indicator window 410 displays to the user how many out of the two thousand contracts have been signed. A “press and hold” button 420 may be selected to sign contracts, displayed within the list of contracts. Reset button 430 may be selected to clear any signatures from all of the contracts.

Contracts may be digitally signed by clicking and holding the “press and hold” button 420. By clicking the button once, one contract in the list of contracts is signed. However, by extending the length of time that the button 420 is held for, more contracts are signed. Specifically, a first contract is signed upon the button 420 being clicked, and a second contract is signed after the button 420 has been held for time period T₁, and a third contract is signed after the button 420 has been held for new time period T₂, and so on.

T₁ is longer than T₂ and as a general rule Tₙ₋₁ is longer than Tₙ. In this way, the rate at which contracts are signed is increased. The time period Tₙ may be arbitrarily reduced in length as “n” increases, or else a lower limit may be reached.

FIG. 4 shows two signed contracts 401, 402 and two unsigned contracts 403, 404. Thus, a user will appreciate that the third contract in the list 403 will be the next contract to be signed if the “press and hold” button 420 is selected. In this way the third contract 403 may be indicated as the current contract in the list.

The “Next” button 440 is provided to allow a user to proceed to the next step in the process once all of the contracts in the list of contracts have been signed. In some embodiments the “Next” button 440 only becomes available for selection by a user once all of the contracts have been signed. However, if all of the contracts have been signed and the user does not advance to the next step for a period of time, the system automatically unwinds the signatures. If this were not done, a user may accidentally advance to the next step in the process, having forgotten that they had signed the contracts. This also helps to conserve the number of contracts pre-signed by users, and to minimise the number of times they have to return to their online account to pre-sign contracts.

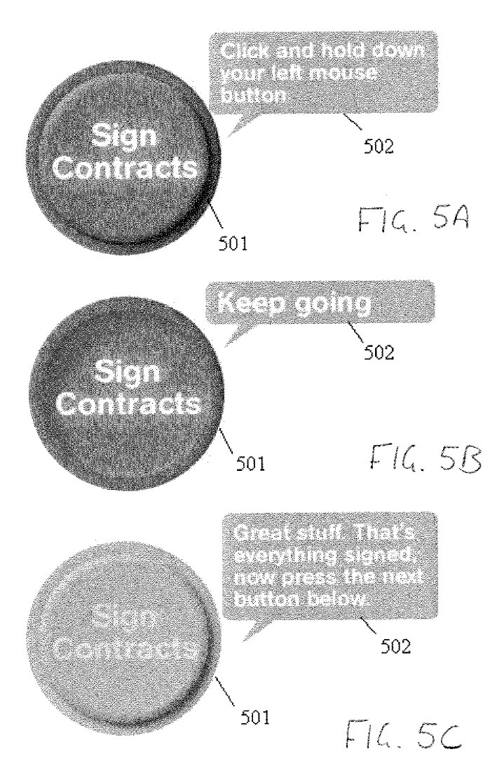

FIGS. 5A-5C show a signing button 501 in various stages during the process of signing a plurality of contracts. In some embodiments the signing button 501 of FIGS. 5A-5C may replace the “press and hold” button 420 of FIG. 4.

The signing button 501 may be selected by operation of a mouse pointer, and a speech-bubble 502 is provided adjacent to the signing button 501 to instruct a user how to proceed, according to the status of the plurality of contracts.

In FIG. 5A the speech-bubble 502 is arranged to indicate that not all of the contracts have been signed; typically this will be the situation before any of the contracts have been signed. Text within the speech-bubble 502 instructs a user how to proceed—by clicking and holding the signing button 501.

In FIG. 5B the speech-bubble 502 is arranged to indicate that holding down the signing button will cause more contracts to be signed. Instructions to the user are provided with text in the speech-bubble. Finally in FIG. 5C, text within the speech-bubble 502 is arranged to indicate to a user that all of the contracts have been signed. The signing button 501 is arranged to be greyed-out, with respect to the signing buttons shown in FIGS. 5A-5B, so that the button 501 is inactive and can no longer be selected. The text within the speech-bubble 502 also indicates that a user may proceed by clicking a button such as the “Next” button 440 shown in FIG. 4.

In other embodiments of the present invention different means may be used to accept a contract, other than using the tab of the scroll bar to pass by a contract. For example, any of the above-identified means (i), (ii) or (iii) may be used to sign a contract, whereas the tab of the scroll bar may be used merely for scrolling through the list of contracts.

In addition other means could be used to sign a contract. A contract may be signed by means that indicate a contract in the list and move in order to indicate a subsequent contract in the list, wherein the act of moving triggers the signing of a contract. Specifically this could be achieved by any of the following (including combinations thereof):

keyboard strokes

mouse (or other pointer) events

scrolling functions of the browser

By way of example, it may be possible to sign a contract by passing over the contract with a mouse-controlled cursor while holding down a certain key on the keyboard.

Although the invention has been described in terms of a borrower accepting a contract, it is equivalently possible that a borrower could make a plurality of offers to lenders for the terms of a loan.

In certain jurisdictions a pre-contract disclosure is required by the lender (for example in the United Kingdom under the Financial Services Regulations 2004). Typically such a disclosure will include the name of the lender along with other information relating to the loan. Each pre-contract disclosure must be individually acknowledged by the borrower. Therefore the borrower may rapidly acknowledge each of the lenders' disclosures by means of digital signatures according to any of the embodiments described above.

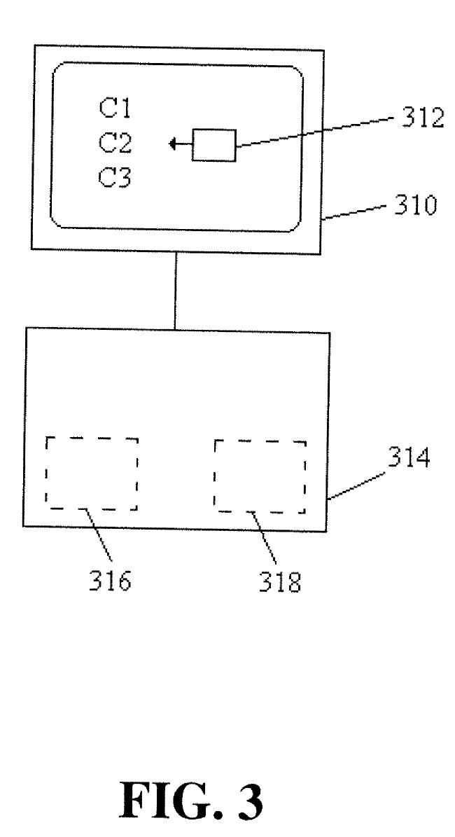

The method of digitally signing a contract described herein may be embodied in an apparatus, as shown in FIG. 3. The apparatus comprises a display unit 310 for displaying part of a list of contracts; in FIG. 3 the contracts displayed in the list are labelled C1, C2 and C3. An indicator 312 indicates one of the contracts in the list and the display unit is connected for control by Central Processing Unit (CPU) 314. In addition CPU 314 comprises a controller unit 316 that a user can use to move the indicator 312 from one contract to another contract in the list. Furthermore CPU 314 comprises a digital signing unit 318 which digitally signs a contract in response to the indication of a current contract moving from one contract to another contract in the list.

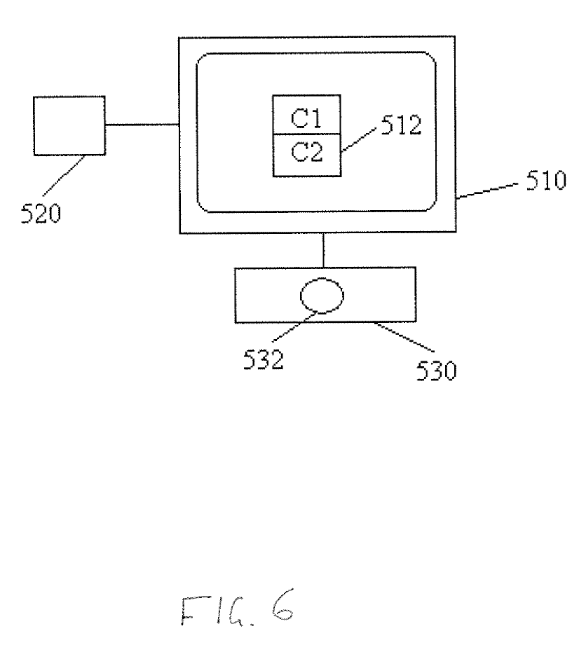

In another embodiment, there may be an apparatus as shown in FIG. 6. FIG. 6 shows a central display and processing unit 510 connected for electrical communication to a digital signing unit 520 for signing contracts, and a controller 530. The central display and processing unit 510 displays a portion of a list of contracts 512, and a user may enable the signing of contracts in the list by interaction with the controller 530. The controller 530 comprises a button 532, and selection of the button sends a contract to the digital signing unit 520 where the contract is signed. Extended selection of the button 532 sends a plurality of contracts to the digital signing unit 520 to be signed.

What is claimed is:

1. A method of digitally signing a plurality of contracts, comprising the steps of:
signing a first contract in response to an action by a signor; and
signing a second contract in response to an action by the signor, wherein the action that signs the second contract is an extension of the same action that is used to sign the first contract.

2. A method according to claim 1 further comprising the step of displaying an identification of a contract before it is signed.

3. A method according to claim 2 further comprising the step of displaying an identification of a contract after it has been signed, together with an indication that the contract has been signed.

4. A method according to claim 3 further comprising the step of displaying at least a portion of a list of contracts.

5. A method according to claim 1 wherein the action that signs the first contract is the selection of a signing tool.

6. A method according to claim 5 wherein the extension of the selection of the signing tool is the continued selection of the signing tool.

7. A method according to claim 5 wherein the signing tool is a displayed icon and the displayed icon is arranged to be selected by a pointer.

8. A method according to claim 1 further comprising the step of displaying instructions for the signor and updating the instructions according to the status of the plurality of contracts.

9. A method according to claim 5 wherein the signing tool becomes inactive after all of the contracts in the plurality of contracts are signed.

10. A method according to claim 1 further comprising the step of displaying an indication of a current contract in a list.

11. A method according to claim 10 wherein the action that signs the first contract is the movement of the displayed indication from one contract to another contract in a list.

12. A method according to claim 11 wherein the extension of the movement of the displayed indication from one contract to another contract in the list is the continuous movement of the displayed indication to yet another contract in the list.

13. A method according to claim 11 wherein a current contract is indicated by adjacency to the tab of a scroll bar.

14. A method according to claim 6 wherein the rate at which contracts are signed is increased during the continued selection of the signing tool.

15. A method according to claim 1 further comprising the step of recording the time of signing of a contract.

16. A method according to claim 15 further comprising the step of displaying the digital signature and the time of signing.

17. A method according to claim 1 further including the step of saving a signed contract electronically.

18. A method according to claim 1 wherein the contract arranged in the list of contracts is a borrowing or lending contract in a system of matching lenders of money with borrowers of money.

19. A method according to claim 1 further comprising the step of examining a contract in a list of contracts for a digital signature, and indicating if all the contracts have been signed.

20. A method according to claim 1 further comprising the step of undoing the signature in a contract after a predetermined time period has elapsed from the signing of the contract.

21. A method of digitally signing a contract comprising the steps of:
displaying at least part of a list of contracts;
displaying an indication of a current contract in the list;
moving the displayed indication of a current contract from one contract to another contract in the list in response to a user input;
and digitally signing a contract in response to the indication of a current contract moving from one contract to another contract in the list.

22. A method according to claim 21 wherein a current contract is indicated by adjacency to the tab of a scroll bar.

23. Apparatus for digitally signing a contract comprising:
a display unit which displays at least part of a list of contracts;
an indicator for indicating a current contract in the list;
a controller for a user that can be used to move the indicator from one contract to another contract in the list;
and a digital signing unit which digitally signs a contract in response to the indication of a current contract moving from one contract to another contract in the list.

24. A method of digitally signing a contract comprising the steps of:
displaying at least part of a list of contracts;
displaying a scroll bar with a scroll tab next to the list of contracts;
moving the scroll tab past a contract in response to a user input;
and digitally signing a contract in response to the scroll tab moving past a contract in the list of contracts.

25. Apparatus for digitally signing a plurality of contracts comprising:
a digital signing unit; and
a controller for a user which enables the user to perform an action, wherein the digital signing unit digitally signs a first contract in response to an action by the user, and digitally signs a second contract in response to an action by the user, wherein the action that signs the second contract is an extension of the same action that is used to sign the first contract.
